(19) United States
(12) Patent Application Publication
(10) Pub. No.: US 2010/0302930 A1
(43) Pub. Date: Dec. 2, 2010

(54) Low Power Quality-Energy Scalable OFDMA Baseband Design

(75) Inventor: Nagendra Nagaraja, Bangalore (IN)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/554,399

(22) Filed: Sep. 4, 2009

Related U.S. Application Data
(60) Provisional application No. 61/182,744, filed on May 31, 2009.

(51) Int. Cl. H04J 11/00

(52) U.S. Cl. 370/210

(57) ABSTRACT

In an energy scalable OFDMA energy metric baseband design for an OFDM transmission process operable using a QoS-guaranteed adaptive resource allocation algorithm, the improvement of effecting power savings and memory access reductions comprising:

generating quality-energy metrics using a modem quality manager module by:
a) means to keep track of the number of repeats from the backend turbo decoder, RCE, type of resource block allocation, and CQI;
b) means to determine the length of cached-FFT and the length of interpolator; and
c) means for scaling computational resources with system QoS parameters to effect power savings and memory access reductions.

### CLAIM OF PRIORITY UNDER 35 USC §119

The present application for a patent claims priority to provisional application No. 61/182,744 entitled “Low Power Quality-Energy Scalable OFDMA Baseband Design” filed May 31, 2009, and assigned to the assignee hereof and hereby expressly incorporated by reference herein.

### BACKGROUND

I. Field

The present invention relates generally to the use of quality-energy scalable modem architecture with support of scaling the computational load dynamically to obtain better energy-efficient modem architecture to support higher data rates of 4G standards like LTE/Wi-Max/Media FLO system.

II. Background

Do to growing demand for high data rate communication, Orthogonal Frequency Division Multiple Access (OFDMA) has become an important technology. Not only is it a modulation scheme but also a multiple access technology, in which each user is allocated a set of orthogonal subcarriers. In addition to overcoming the inter-symbol interference, an OFDMA system also mitigates the multiple access interference due to the orthogonality among subcarriers. Compared to static multiple access schemes, the OFDMA technique considers the channel information and allows multiple users to transmit simultaneously on the different subcarriers per OFDM symbol. Further, through dynamic resource allocation, it attains multiuser diversity gain.

OFDMA/OFDM is a de-facto air-interface for next generation wireless standards like LTE/Wi-Max/Media FLO system and these standards are deployed in portable devices which are constrained for power. In this regard dynamically (computational load) scalable OFDM baseband design is very important to attain higher bit rates proposed by these standards and to provide longer battery life with better user experience.

Min Li et al.′ provide a method that enables the scalability in OFDMA modulation that scales the modulation-accuracy and computation-load according to modulation scheme and coding rate by replacing the original large-size IFFT based modulator by its scalable approximation, which consists of a variable-size IFFT, a variable-size linear-interpolator and a signal rotator. By alternating the percentage of interpolated signals, the modulator can achieve a flexible tradeoff between modulation-accuracy and computation-load.

In Chen et al.², next-generation mobile communication systems has adopted orthogonal frequency division multiple access (OFDMA) technology for multi-user scenario, in which subcarriers can be grouped as resource blocks or subchannels and allocated to different users. As such, only partial subcarriers in one OFDM symbol may be used by one user end (UE). In this situation, more redundant power consumption is produced by the FFT computation for OFDM demodulation in the UE. Among the available FFT architectures, cached-FFT has much regularity and lower power consumption than others. Thus, a partial FFT algorithm is applied to the cached-FFT architecture for power reduction of OFDMA UE. The partial cached-FFT algorithm is used to control the operation of the cached-FFT processor for different proposals of OFDMA resource block allocation schemes, thereby reducing the computing power.

Li et al. disclose that FFT can be scaled with Quality-energy trade-off; but does not teach the metrics or QoS (quality of service) parameter that is needed to affect this trade-off. Li et al. also leaves implementation of the exact N/L FFT open ended.

Finally, Li et al. does not address the different RB or subchannel allocation scheme-it assumes that the resource block will have contiguous distribution.

In other words, Li et al cannot handle non-contiguous RB allocation and it proposes just varying the FFT length and carrying on the rest of the transform by interpolation. While this is good for the RB (which is continuous in SC-FDMA), for WiMAX it cannot be directly applied because the RB is not contiguous.

On the other hand, Chen et al. disclose the intermediate RB distribution type of non-contiguous sub blocks, and refers to this as a comb distribution; however, the scheme of Chen et al does not disclose varying the FFT length and using interpolation. Neither does Chen et al. provide an addressing scheme when some part of FFT is carried out by interpolation. Instead, it just provides an addressing scheme for a different RB allocation in LTE.

### SUMMARY

Embodiments disclosed herein address the above stated needs and shortcomings in the prior art by: affecting additional power savings by modifying the Quality-Energy metrics for the FFT. The use of partial FFT by the combination of smaller length exact FFT and interpolation and rotation, with addition to this of both interpolation length and FFT length that can be varied depending on the QoS requirement and the type of resource block allocation.

This is done by generating quality-energy metrics with various inputs, using modem quality manager module;

using a modem quality manager which keeps track of the number of repeats from the backend turbo decoder, RCE (Relative Constellation Error), type of resource block allocation and CQI (channel quality indicator);

deciding on the length of Exact Cached FFT and length of interpolator; and dynamic scaling of computational resources with the help of the system QoS parameters.

To support higher data rates of 4G standards such as LTE/Media FLO/Wi-Max, computational load is increased on modems, and this computation load due to MIMOOFDMA processing in these standards is significantly large. This increased overall power consumption of baseband processors shortens the mobile devices' battery life. Further, since power consumption also limits the air-interface rates, there is a need for a mobile device with better energy-efficient modem architecture or design to resolve or lessen these issues.

### BRIEF DESCRIPTION OF THE DRAWINGS

FIG. 1 is a flow chart of the modem RX and TX FFT/IFFT operation with the QoS manager.

FIG. 2 is a diagram depicting the QoS manager function.

FIG. 3 is a diagram of a resource block in time-frequency tile showing users A, B, C and D as benefited by additional power savings by modifying the Quality-Energy metrics for the FFT.

FIG. 4 is a graph showing the OFDMA modem power consumption versus the number of subcarriers in the OFDMA multiuser symbol.

FIG. 5A is flow chart depicting the full modem data path for the RX in the LTE/Wi-Max/Media FLO.

FIG. 5B is a flow chart depicting the full modem data path for the TX in the LTE/Wi-Max/Media FLO.

### DETAILED DESCRIPTION

The word “exemplary” is used herein to mean “serving as an example, instance, or illustration”. Any embodiment described herein as exemplary is not necessarily to be construed as preferred or advantageous over other embodiments.

It is clear that Li et al relates only that FFT can be scaled with Quality-energy trade-off; however, it never suggests what are the metrics or QoS parameter that is needed to trade with.

Also, in the partial cached FFT method of Chen et al., the type of resource blocks allocation scheme plays an important role in determining power efficiency of the FFT algorithm; however, the scheme neither disclose varying the FFT length and using interpolation nor providing an addressing scheme if some part of the FFT is carried out by interpolation. Therefore, for a given resource blocks allocation, certain FFT algorithms may be optimal.

In the case of multiple resource block allocation, it is necessary to use partial cache-FFT algorithm to reduce the number of butterfly operations and memory access. That way, by the use of a modem Quality manager, very optimal power can be obtained.

The present innovation advances the prior art contributions in that it scales the exact FTT length to maintain RCE and reduces the error rate by obtaining the information from a backend decoder, type of RB or subcarrier allocation and the CQI from the transmitter side. Therefore, it is apparent that the Quality-energy scalability is different than that at the TX and RX described in the prior art.

For example, the TX and RX is as follows:

TX Q-E scalability metrics:
1. RCE threshold as specified by standard
2. FOH ACK channel density of NACKs, which indicates the number of repeats due to decode failure
3. CQI information
4. codebook from receiver in case of precoding MIMO
5. Type of resource block

allocation RX Q-E scalability

metrics:
1. Type of resource block allocation
2. NACK density

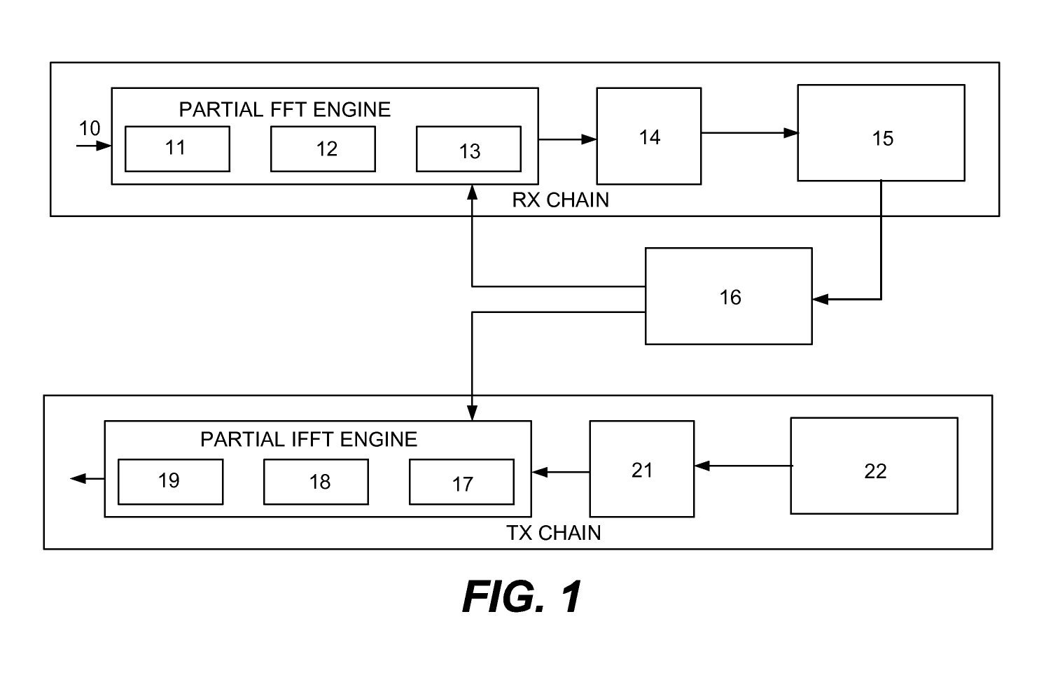

Reference is now made to FIG. 1 which shows the modem RX and TX FFT/IFFT operation with the QoS manager.

As can be seen in FIG. 1, the invention obtains an optimal IFFT/FFT engine that is reusable across many operations such as filtering, modulation/demodulation and channel estimation by providing a flexible architecture that divides whole FFT/IFFT 10, into exact N/L FFT 11, interpolation of length 12 and rotator 13, and further makes it useable for different allocation schemes by using different address schemes. For instance, it can be seen that routing from rotator 13 proceeds to a deinterleaver (Time or Frequency) 14, and thereafter to a CTC decoder 15, whereupon the QoS manager 16, may re-route to either RX chain or the TX chain, and through allocations of a rotator 17, L point interpolator 18, to provide an exact N/L IFFT 19. Also, the CTC encoder 20, may route through interleaver (Time or Frequency) 21 to rotator 17, L point interpolator 18 and an exact N/L IFFT 19 in operation with the QoS manager 16.

It should be noted that IFFT/FFT is used for many other purposes like channel estimation and filtering in OFDMA modem, and these operations can be done with exact FFT rather than using partial FFT. The QoS manager monitors or keeps track of the operation that is done by information from the MDSP and accordingly provides FFT/IFFT length for particular operations.

Scalability or trade-off comes from parameter L, as given in Li et al. The error between exact modulation and the interpolated modulation is a monotonic function of L.

Hence, by altering L, the accuracy of modulation can be scaled. As given in Li et al. this is very useful to reduce the computation-load and associated energy-consumption on a real-life system.

However, the N/L exact FFT/IFFT as shown in FIG. 1 is calculated using the cached IFFT/FFT architecture and addressing scheme. Currently QCT FFTE follows the cached FFT algorithm. But it does not follow different addressing for different subcarrier allocation or Resource block allocation as specified in Wi-Max or LTE. This invention in conjunction to calculating Partial FFT as seen in Li et al., has exact FFT and is a cached FFT architecture with a different addressing scheme for different resource allocation strategies.

While the strategy of partial FFT in Li et al. can reduce computation load significantly, if it is assumed that resource block allocation is always localized. But if we consider comb distributed or sub carrier level RB allocation, then results of Li et al. may vary further. This is because the addressing scheme should vary depending on the RB allocation of the exact FFT. As Li et al. already suggests, there is a scope for optimizing lower level details like addressing, Butterfly operation and memory organization.

The low power quality-energy scalable OFDMA base band design is a power saver for the QCT modem, and this can be achieved by having a QoS Manager in the modem and some change in FFTE addressing.

Additional power savings by these metrics provide a tradeoff between Modulation Accuracy and Error correction, with compliance to completely error free reception. Most of the time FLOPS equivalent efforts involved in the backend Turbo decoder is constant. For example, if the CQI is good, then decoding is easier. This enables reducing the length of FFT and interpolating most of the data at the receiver, assuming that the Turbo decoder performs the same number of FLOPS equivalent operation to decode. The accurate model equation between CQI and FFT length L is determined by simulation. So, if the CQI is good enough, then the decoder will converge quickly even if the demodulation is inaccurate to a certain extent. This can be represented by the following equation:

H*X=Y, So X=Turbo decode (YIH) equation. So there is a trade off of determining either H accurately or Y accurately in order to determine X accurately. If we have found H accurately, assuming that efforts involved in finding X is independent of the accuracy of Y until some error threshold delta (Y). So if we have the accuracy of H above some threshold delta (H), then we can approximate Y to some delta (Y), and save some power by varying the FFT length L. The same applies to the HARQ NACK density, as is apparent. If there are lesser repeats, the length of FFT can be scaled down to allow the Turbo decoder to perform decoding. However, in case of higher repeats the FFT can be made very accurate. Again, the FLOPS equivalent of efforts involved at the Turbo decoder in decoding will be constant until some threshold of inaccuracy of the FFT. The exact equation to determine this threshold is determined by simulation. But this is a very visible trade off between demodulation accuracy and error correction.

Power Consumption of FFTE without QE Scalability

According to the FFTE HDD document, the FFT is calculated on the entire bandwidth of RB, where no interpolation approximation is possible and no QE is used. Total estimated power consumption is given by number of Butterfly operations required. In current FFTE, the number of butterfly operation/Cycle count required for 4096 FFT is

4096 Point FFT Cycles
The number of cycles needed to calculate 4096 point FFT are:
   4096-point FFT=>8×8×8×8=>4 stages of operation
   One block 64 samples
   Cycles for doing FFT for one block is 20 cycles.

$$Number of blocks in each stage = \frac{N}{{r}^{2}} = 64 blocks . \\ Cycles for 4 stages = 4 \times 64 blocks \text{/} stage \times 20$$

$$cycles \text{/} block = 5120 cycles$$

No extra transpose stage is required
Total cycles for 4096-point FFT are 5120 cycles.

This is currently implemented by FFT Engine consumption. Assuming that each cycle consumes W watts of power, we have 5120×W watts power consumption in current QCT FFTE. In the present invention, just considering the RCE based on Li et al, there is a saving of cycle counts as shown by Table I.

TABLE I
Table for Run Time Reconfiguration (Partial)

| Modu. | Coding | Maximal | RCE | Interp. | Cycle |
|---|---|---|---|---|---|
| Scheme | Rate | RCE | Margin | Factor | Reduction |
| BPSK | 1/2 | −13.0 dB | 5.0 dB | 16 | 92% |
| QPSK | 1/2 | −16.0 dB | 5.0 dB | 16 | 92% |
| QPSK | 3/4 | −18.5 dB | 5.0 dB | 16 | 92% |
| 16QAM | 1/2 | −21.5 dB | 5.0 dB | 8 | 84% |
| 16QAM | 3/4 | −25.0 dB | 5.0 dB | 8 | 84% |
| 64QAM | 2/3 | −28.5 dB | 5.0 dB | 8 | 84% |
| 64QAM | 3/4 | −31.0 dB | 5.0 dB | 4 | 68% |
| 16QAM | 1/2 | −21.5 dB | 10.0 dB | 8 | 84% |
| 16QAM | 3/4 | −25.0 dB | 10.0 dB | 4 | 68% |

In any case, the worst case cycle saving from only reducing RCE is given as 68%. So for 4K FFT we are going to save 5120×68%=3481 cycles. Assuming FFTE consumes W watts for each cycle, we save 3481 W watts of power from RCE, as given in Li et al.

Now considering that we use similar trade-off for following parameters
1. FOH ACK channel density of NACKs, which indicates the number of repeats due to decode failure
2. CQI information
3. codebook from receiver in case of precoding MIMO
4. Type of resource block allocation
5. RX Q-E scalability metrics
6. Type of resource block allocation
7. NACK density

For each of these parameters we can consider a further incremental gain of 30-50% by increasing the interpolation factor when these parameter values are below the threshold.

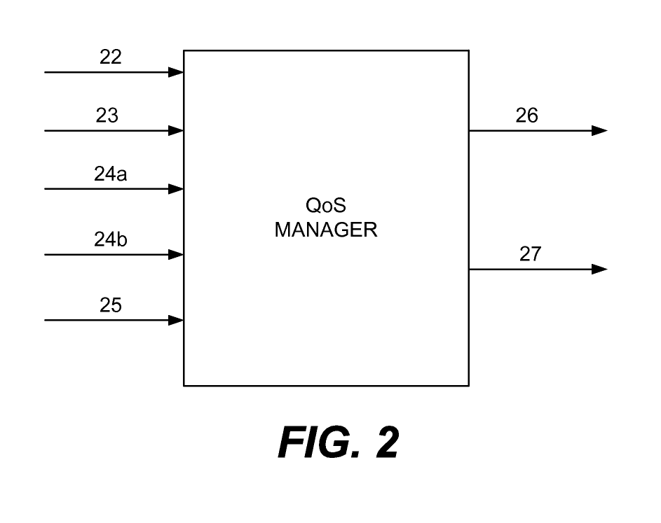

The logic in this regard can be seen by the diagram depicting the Qos manager function in FIG. 2, where the QoS assesses or receives the NACK density 22, CQI information 23, codebook from receiver in case of precoding MIMO 24a, codebook from receiver in case of precoding MIMO 24b, and type of RB allocation 25. The Raleigh fading channel was used for calculating the effect of using NACK density, CQI and MIMO precoder coefficient; however, the same can be mapped to Rician channel or other models as well. With these added metrics the logics for monitoring of the QoS manager utilizes an interpolation factor 26 and a change in the addressing scheme 27 to effect power saving numbers of at least 68% of the power in Li et al. and 30% memory access reduction compared to what is generally used in current FFTE. Assuming that with the RCE only we have an interpolation factor as 4 and we save 68% cycle count equivalent of power and further we apply above metrics considering that we have enough Error correction capability (Turbo decoder), we can get worst case interpolation factor of 4, that takes us to interpolation factor of 16 overall including RCE and other metrics above. So we get total power saving as 5120−714=4406 cycles or 86% of power that is saved overall. Using this innovation parameter alone we can save 68% of power in the worst case. This is when parameters are favorable. This means we have a good CQI or Lower NACK density or addressing scheme where power can be significantly reduced by reducing the number of butterfly operations.

If this is too optimistic because we have not considered how much percentage of the time the conditions will be conducive for power saving, we may consider the Raligh/Recian fading channel. We get average fade duration given by the:

### Level Crossing Rate

The level crossing rate is a measure of the rapidity of the fading. It quantifies how often the fading crosses some threshold, usually in the positive-going direction. For Rayleigh fading, the level crossing rate is:

LCR=\sqrt{2π}f_{d}pe^{-p}^{²}

where fd is the maximum Doppler shift and P is the threshold level normalized to the root mean square (RMS) signal level:

$$ρ = \frac{{R}_{thresh}}{{R}_{rms}}$$

### Average Fade Duration

The average fade duration quantifies how long the signal spends below the threshold P.

$$AFD = \frac{{e}^{{ρ}^{2}} - 1}{ρ {f}_{d} \sqrt{2 π}}$$

For Rayleigh fading, the average fade duration is

The level crossing rate and average fade duration taken together gives a useful means of characterizing the severity of the fading over time.

For a particular normalized threshold value p, the product of the average fade duration and the level crossing rate is a constant, and is given by

AFD×LCR=1−e^{-p}^{²}

So Total power saving is given by:
Total power saving=(1−Average duration of fade)×Total power saving during favorable conditions=(1−(1−e−^{p2)}) Total power saving during favorable conditions=e−^{P2}×Total power saving during favorable condition=e−^{p2}×86% of total power consumed by FFT engine.

If we leave out RCE and consider additional parameters proposed in this invention, we get

Power saving=e−^{p2}×68% of total power consumed by FFT engine.

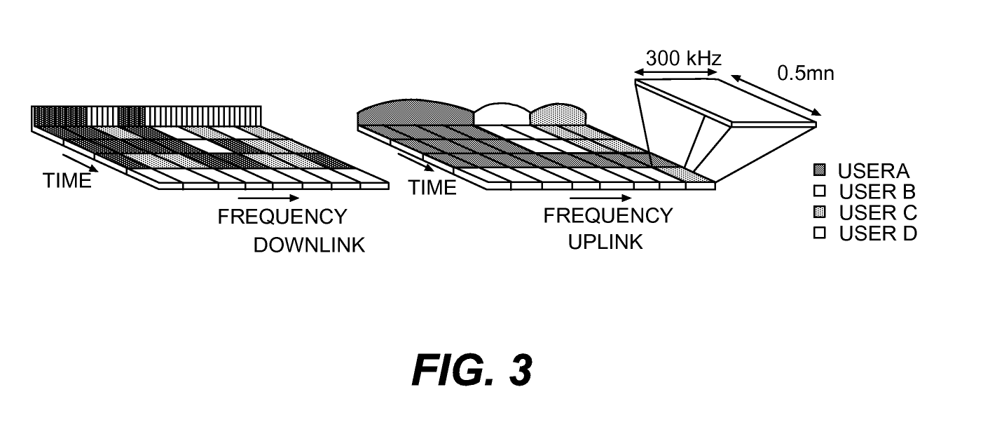

The savings of additional power, utilizing the innovation scheme can be seen in FIG. 3, which is a diagram of a resource block in time-frequency tile showing users A, B, C and D as benefited by additional power savings by modifying the Quality-Energy metrics for the FFT.

We can save additional power even during fades using an addressing scheme suitable to particular RBs as given in Chen et al. This can be a saving on memory access.

This requires not much additional logic apart from the QoS manager.

By default we can assume QCT FFT access memory 130 times for 64 point FFT (it can be worse than this). So if we assume that we are using any one of RB allocation and are aware of this scheme, with the help of QoS manager. We can reduce number of memory access to 80-100 cycles. So this can save 30% of memory access power and some amount of BU power as well, since we can shut off butter fly units. But as given in Chen et al., we are not claiming power reduction in complex addition and complex multiplication again. Since it may be overkill and may overlap with savings from metrics mentioned in this invention.

So total additional power saving from Li et al. and Chen et al. as applied in this invention is:

Power saving=e−^{p2}×68% of total power consumed by FFT engine.

Power saving from reducing memoryaccess=30%-50% of overall memory access power.

Total power saving=e−^{p2}×68% of total power consumed by FFT engine (complex addition and multiplication and reduction in number of cycles)+30%-50% of overall memory access power,

Where p is related to sensitivity of receiver, since this gives a threshold below which we can consider channel to be in fade. This is also defined as

$$p = \frac{{R}_{thresh}}{{R}_{rms}}$$

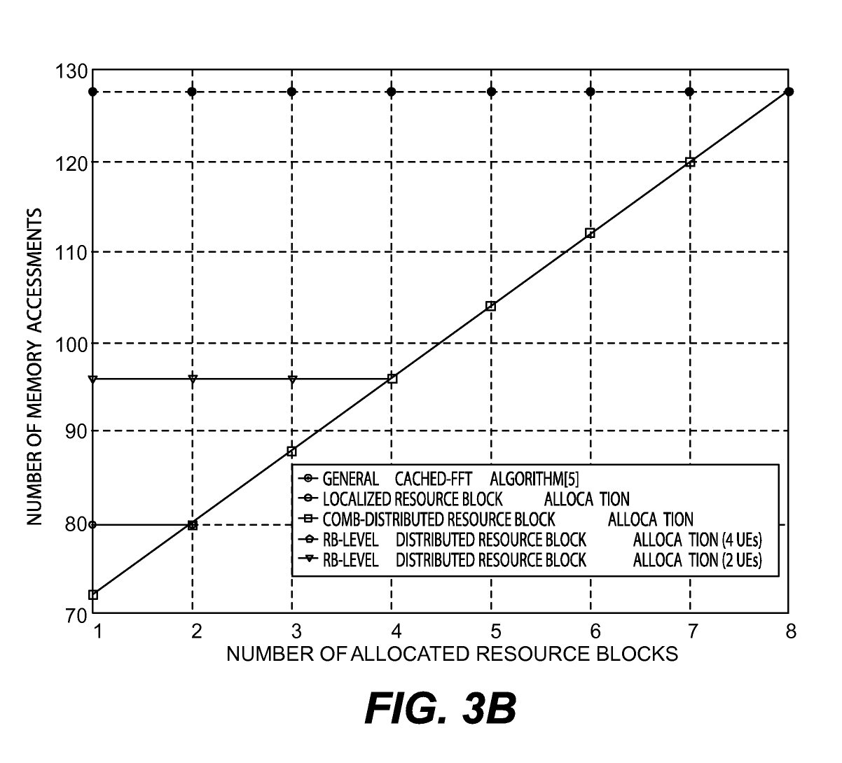

As can be seen from FIG. 4, which is a graph depicting the OFDMA modem power consumption versus the number of subcarriers in the OFDMA multiuser symbol, line A shows the case without power reduction techniques like memory address optimization, channel awareness and approximate, FFT; line B shows the prior art case with FFT memory address optimization or using approximate FFT with the aid of interpolation; and line C is the case of the current innovation which incorporates the use of various channel informations to reduce power, plus techniques used in the prior art.

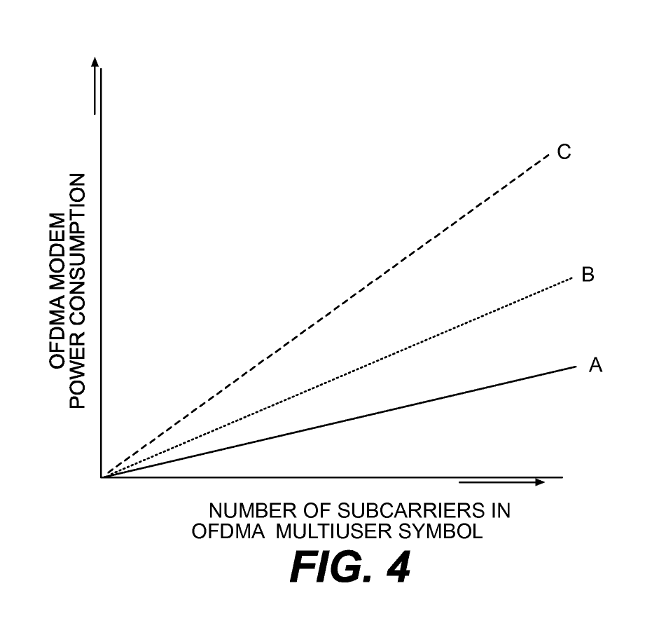

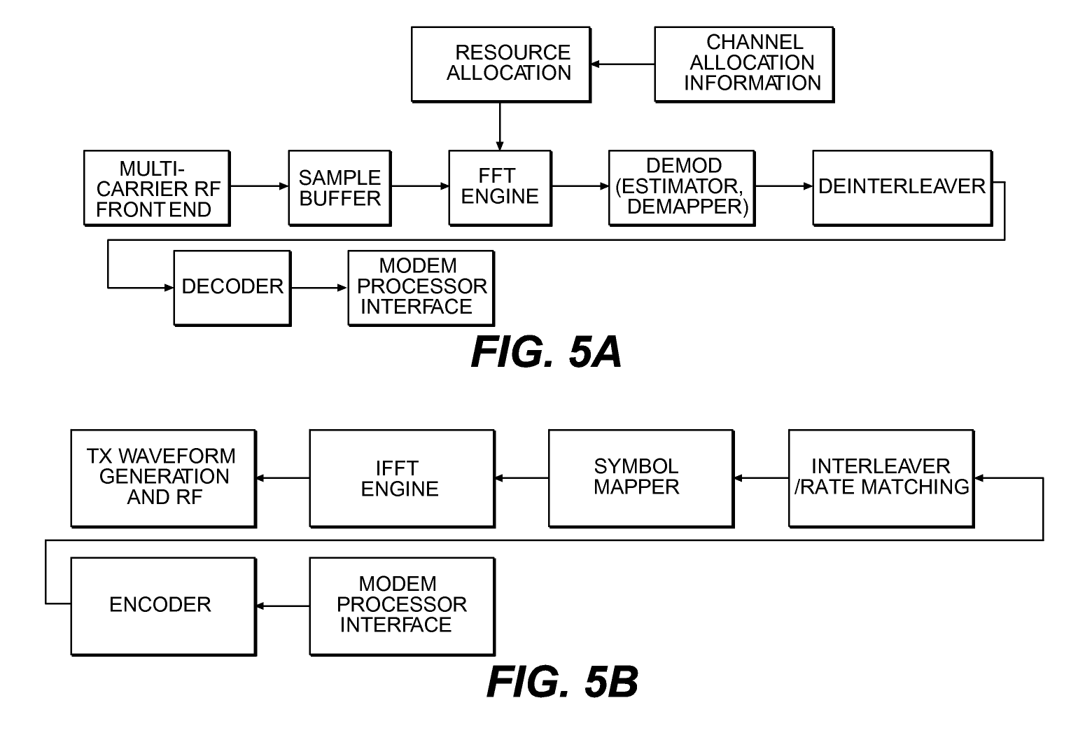

The full modem data path in which the advance to the art of the present innovations are applicable can be seen from the LTE/Wi Max/Media FLO systems of FIGS. 5A and 5B, wherein 5A is a flow chart depicting the full modem data path for the RX in the LTE/Wi Max/Media FLO and FIG. 5B is a flow chart depicting the full modem data path for the TX in the LTE/Wi Max/Media FLO.

Those of skill in the art would understand that information and signals may be represented using any of a variety of different technologies and techniques. For example, data, instructions, commands, information, signals, bits, symbols, and chips that may
be referenced throughout the above description may be represented by voltages,
currents, electromagnetic waves, magnetic fields or particles, optical fields or particles, or
any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

I claim:

1. In an energy scalable OFDMA energy metric baseband design for an OFDM transmission process operable using a QoS-guaranteed adaptive resource allocation algorithm, the improvement of effecting power savings and memory access reductions comprising:
generating quality-energy metrics using a modem quality manager module by:
a) means to keep track of the number of repeats from the backend turbo decoder, RCE, type of resource block allocation, and CQI;
b) means to determine the length of cached-FFT and the length of interpolator; and
c) means for scaling computational resources with system QoS parameters to effect power savings and memory access reductions.

2. The power savings and memory access reductions process of claim 1, wherein said transmission processing is a MIMO OFDMA process.

3. The power savings and memory access reductions process of claim 2, wherein the exact FFT length is scaled to maintain the RCE.

4. The power savings and memory access reductions process of claim 2, wherein the exact FFT length is scaled to reduce the error rate by obtaining information from a backend decoder.

5. The power savings and memory access reductions process of claim 2, wherein the exact FFT length is scaled to obtain information of the RB or subcarrier allocation.

6. The power savings and memory access reductions process of claim 2, wherein the exact FFT length is scaled to obtain information of the CQI from the transmitter side.

7. The power savings and memory access reductions process of claim 1, wherein the QoS monitors the operation performed by information from the MDSP and provides a FFT/IFFT length for the operation.

8. The power savings and memory access reductions process of claim 1, wherein said transmission processing is LTE/Wi MAX/Media FLO system.

9. The power savings and memory access reductions process of claim 7, wherein the exact FFT length is scaled to maintain the RCE.

10. The power savings and memory access reductions process of claim 8, wherein the exact FFT length is scaled to reduce the error rate by obtaining information from a backend decoder.

11. The power savings and memory access reductions process of claim 8, wherein the exact FFT length is scaled to obtain information of the RB or subcarrier allocation.

12. The power savings and memory access reductions process of claim 8, wherein the exact FFT length is scaled to obtain information of the CQI from the transmitter side.

13. The power savings and memory access reductions process of claim 8, wherein the QoS monitors the operation performed by information from the MDSP and provides a FFT/IFFT length for the operation.

14. The power savings and memory access reductions process of claim 1, wherein said transmission processing is a LTE process.

15. The power savings and memory access reductions process of claim 14, wherein the exact FFT length is scaled to maintain the RCE.

16. The power savings and memory access reductions process of claim 14, wherein the exact FFT length is scaled to reduce the error rate by obtaining information from a backend decoder.

17. The power savings and memory access reductions process of claim 14, wherein the exact FFT length is scaled to obtain information of the RB or subcarrier allocation.

18. The power savings and memory access reductions process of claim 14, wherein the exact FFT length is scaled to obtain information of the CQI from the transmitter side.

19. The power savings and memory access reductions process of claim 1, wherein said transmissions processing is a LTE/Wi MAX/Media FLO system.

20. The power savings and memory access reductions process of claim 19, wherein the exact FFT length is scaled to maintain the RCE.

21. The power savings and memory access reductions process of claim 19, wherein the exact FFT length is scaled to reduce the error rate by obtaining information from the backend decoder.

22. The power savings and memory access reductions process of claim 19, wherein the exact FFT length is scaled to obtain information of the RB or subcarrier allocation.

23. The power savings and memory access reductions process of claim 19, wherein the exact FFT length is scaled to obtain information of the CQI from the transmitter side.

24. The power savings and memory access reductions process of claim 19, wherein the QoS monitors the operation performed by information from the MDSP and provides a FFT/IFFT length from the operation.
